(19) United States
(12) Patent Application Publication
(10) Pub. No.: US 2011/0247707 A1
(43) Pub. Date: Oct. 13, 2011

(54) MICROFLUIDIC CHIP DEVICE AND METHOD OF MAKING THE SAME

(76) Inventors: Chien-Chong Hong, Hsinchu County (TW); Jui-Chun Chen, Taipei City (TW)

(21) Appl. No.: 12/871,089

(22) Filed: Aug. 30, 2010

(30) Foreign Application Priority Data
Apr. 8, 2010 (TW) 099110881

(51) Int. Cl. F15B 13/00; B32B 38/00; B32B 37/02

(52) U.S. Cl. 137/560; 156/60

(57) ABSTRACT

A microfluidic chip device includes a substrate layer and a microfluidic layer. The substrate layer is made from a shape memory polymer, and includes a transformative portion that can change in volume when changing in shape between a memory shape and a temporary shape. The microfluidic layer is laminated with the substrate layer and has a microchannel that is in fluid communication with the transformative portion. The transformative portion produces a fluid driving pressure within the microchannel when changing between the memory shape and the temporary shape. A method of making the microfluidic chip device is also disclosed.

### CROSS-REFERENCE TO RELATED APPLICATION

This application claims priority of Taiwanese application no. 099110881, filed on Apr. 8, 2010.

### BACKGROUND OF THE INVENTION

1. Field of the Invention

This invention relates to a microfluidic chip device and a method of making the same, more particularly to a microfluidic chip device made using a shape memory polymer and a method of making the same.

2. Description of the Related Art

A conventional microfluidic device includes a micropump that is able to transport a fluid and control the same, and a microvalve that is capable of regulating a flow direction and a flow rate of the fluid in a channel of the microfluidic device. The micropump generally falls in to one of two categories: a displacement rump and a dynamic pump. The displacement pump can be further classified as a peristaltic type or a reciprocating type. The microvalve may be active or passive, and may include a mechanical moving part or a non-mechanical moving part.

M. Koch et al. proposed a microfluidic system including a reciprocal it a micropump based on a piezoelectric material (M. Koch, N., Harris, Alan G. R. Ivans, Neil M. White and Arthur Brunnschweiler, A Novel Micromachined Pump Based On Thick-Film Piezoelectric Actuation, Sensors and Actuators A: Physical, vol. 70, pp. 98-103, 1998). Specifically, the piezoelectric material is disposed on a unit of three silicon layers that are stacked together. A cantilever beam structure capable of vibrating is used to induce a unidirectional flow of a fluid. When voltage is applied, the piezoelectric material and a membrane reciprocate, thereby being able to transport the fluid.

Zengerle et al. proposed a microfluidic system that includes an electrostatic micropump made from a silicon material (Optoelectronics and Photonics: Principles and Practices. 1st ed., Prentice Hall, 2001). The electrostatic micropump employs a cantilever beam structure as a flap valve.

Compared to the structures of the aforementioned conventional microfluidic systems, a microfluidic system made from a polymer can be easily produced, is more biologically compatible, and can be made using a process that does not have limitations of a semiconductor manufacturing process. Consequently, polymeric materials, which are able to partially integrate a microvalve and a microfluidic driving source, have been continuously developed.

R. Liu et al. used an acrylic acid-hydroxyethyl methacrylate (AA/HFMA) hydrogel subjected to an ultraviolet curing process to construct a microvalve (Liu R, Yu Q and Beebe D J, “Fabrication and Characterization of Hydrogel-Based Microvalves” J. Microelectromech. Syst., vol. 11, pp. 45-53, 2002). The hydrogel changes in volume at different pH. Therefore, by virtue of volume changes of the hydrogel in buffer solutions having different pH values, a polydimethylsiloxane (POMS) membrane can be pushed. David T. Eddington et al. utilised an array of pH-responsive hydrogels and a PDMS membrane to produce a microfluidic device (David T. Eddington and David J. Beebe, “A Valved Responsive Hydrogel Microdispensing Device With Integrated Pressure Source”, Journal of Microelectro-mechanical Systems, vol. 13, no. 4, 2004). In the aforesaid two literatures, an external syringe pump is required to inject a buffer solution.

However, the aforementioned conventional partially integrated microfluidic systems require a pressure controlling device and pipes to serve as a driving source for the fluid. Even though a microfluidic chip has a small size, an external driving source having a large size is necessary for the aforementioned conventional partially integrated microfluidic systems. Accordingly, the aforementioned conventional partially integrated microfluidic systems are not convenient to use.

C. C. Hong et al. sealed a pressurized gas in a microcavity with a thermoplastic membrane, utilized electroplated nickel as a heater material, and packaged the aforementioned elements and a microfluidic chip together (J. Microtech, Micrceng. 17 (2007:410-417). When the sealing membrane is heated and melted by the heater, the pressurized gas in the microcavity is released and serves as a driving scarce to push a fluid to flow into the microfluidic chip.

Kuo-Yao Weng et al. encapsulated vacuum capillaries in a flexible and elastic film (The Royal Society of Chemistry 2008, Lab Chip, 2008, 8, 1216-1219). When the vacuum capillaries in the film are broken by an external force, pneumatic forces are generated to suck a fluid into a microfluidic system. A vacuum capillary pneumatic pump serves as a driving source.

Nevertheless, a driving source, which can induce actuation of a fluid by creating a positive pressure or a negative pressure, is generally made via a complicated process, must be precisely controlled to successfully accomplish the actuation of the fluid, and is normally not reusable. Thus, how to provide a simple method of integrating a microfluidic system and a driving source is the subject of endeavor in the present invention.

### SUMMARY OF THE INVENTION

The object of the present invention is to provide a microfluidic chip device that can overcome the aforesaid drawbacks of the prior art, and a method of making the same.

According to one aspect of this invention, a method of making a microfluidic chip device is provided. The method comprises: forming a shape memory polymer into a substrate layer having a transformative portion with a memory shape; processing the substrate layer to change the transformative portion into a temporary shape; and laminating the substrate layer with a microfluidic layer so that a microchannel of the microfluidic layer is connected fluidly to the transformative portion having the temporary shape. The memory shape is recovered when the transformative portion is activated by an external stimulus, and a fluid driving pressure is produced within the microchannel when the memory shape is recovered.

According to another aspect of this invention, a microfluidic chip device is provided. The microfluidic chip device includes a substrate layer and a microfluidic layer. The substrate layer is made from a shape memory polymer, and includes a transformative portion that can change in volume when changing in shape between a memory shape and a temporary shape. The microfluidic layer is laminated with the substrate layer and has a microchannel that is in fluid communication with the transformative portion. The transformative portion produces a fluid driving pressure within the microchannel when changing between the memory shape and the temporary shape.

### BRIEF DESCRIPTION OF THE DRAWINGS

Other features and advantages of the present invention will become an parent in the following detailed description of the preferred embodiments of this invention, with reference to the accompanying drawings, in which:

FIG. 1 is a schematic diagram showing the preferred embodiment of a method of making a microfluidic chip device according to the present invention;

FIG. 2 is a schematic perspective view to illustrate the preferred embodiment of a microfluidic chip device according to the present invention; and

FIG. 3 shows change of a transformative portion of the preferred embodiment shown in FIG. 2 from a temporary shape to a memory shape for driving a fluid.

### DETAILED DESCRIPTION OF THE PREFERRED EMBODIMENTS

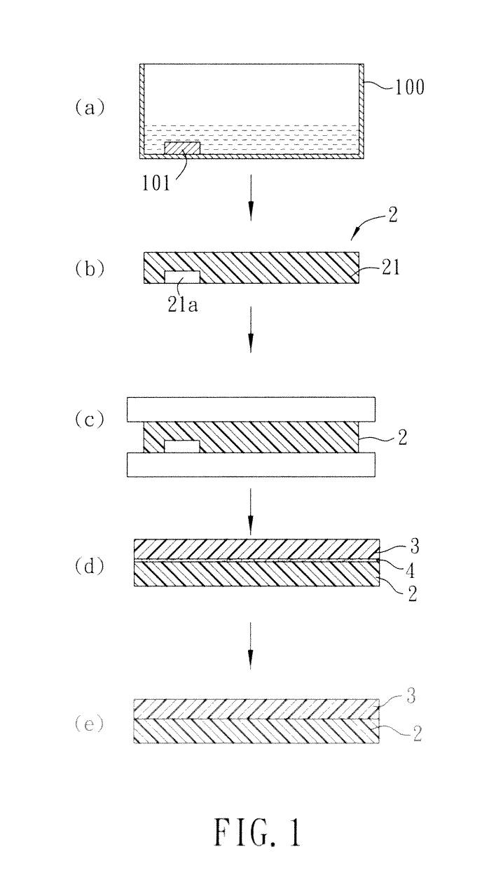

FIG. 1 shows the preferred embodiment of a method of making a microfluidic chip device according to the present invention.

As shown in step (a) of FIG. 1, a monomer composition, which contains a monomer that can be polymerized to form a shape memory polymer (SMP), is disposed in a mold 100 having a predetermined pattern. Specifically, the predetermined pattern of the mold 100 is composed of a protrusion 101 of the mold 100, which extends upwardly from a bottom portion of the mold 100. The monomer composition in the mold 100 is subjected to polymerization so as to form the SMP. The SMP is molded into a substrate layer 2 raving a transformative portion 21 with a memory shape by virtue of the mold 100. The memory shape of the transformative portion 21 corresponds to the pattern of the mold 100. In this embodiment, the monomer composition is disposed in the mold 100 by a casting process. Since the mold 100 has the protrusion 101, the transformative portion 21 with the memory share has an indentation 21a corresponding to the protrusion 101 of the mold 100. The memory shape of the transformative portion 21 is a permanent shape.

The SMP produced from the monomer composition may fall into one of the following four categories: a SMP composed of a covalently cross-linked glassy thermoset network, a SMP composed of a covalently cross-linked semi-crystalline network, a SMP composed of a physically cross-linked glassy copolymer, and a SMP composed of a physically cross-linked semi-crystalline block copolymer. Since the SMP composed of the covalently cross-linked glassy thermoset network has a sharp glass transition temperature (T_{g}) curve and has a structure of a cross-linked network, the same is able to repress molecular motion between chains. Accordingly, the SMP composed of the covalently cross-linked glassy thermoset network is capable of accomplishing shape-fixing and rapid shape-recovery, and is preferably used in the method of the present invention. In this embodiment, the monomer in the monomer composition is selected from the group consisting of methyl methacrylate (MMA) and butyl metharylate (BMA).

The monomer composition may further contain polyhedral oligosilsesquioxane (POSS) that is an inorganic/organic hybrid molecule, and that contains corn an inorganic silicon-oxygen cage and compatibilizing organic groups pendant to each silicon corner of the cage. Thermal stability and melt flowability of the SMP can be increased by virtue of POSS, and a mechanical property of the SMP is not adversely affected by POSS.

As shown in steps (b) and (c) of FIG. 1, the substrate layer 2 is removed from the mold 100, and the transformative portion 21 is subsequently hot-pressed so that the transformative portion 21 is deformed and is hence changed from the memory shape to a temporary shape. Specifically, the indentation 21a of the transformative portion 21 disappears when the transformative portion 21 is changed into the temporary shape after the hot pressing step. The transformative portion 21 with the temporary shape, which has no indentation 21a, is then cooled down. In this embodiment, the substrate layer 2 having the transformative portion 21 with the memory shape is heated to a temperature higher than T_{g} of the substrate layer 2, and the transformative portion 21 is hot-pressed by a hot-embossing machine. When the transformative portion 21 with the temporary shape is cooled down to a temperature lower than T_{g} thereof, internal energy is stored, and kinetic energy of molecules is reduced. Thus, the transformative portion 21 can maintain the temporary shape thereof.

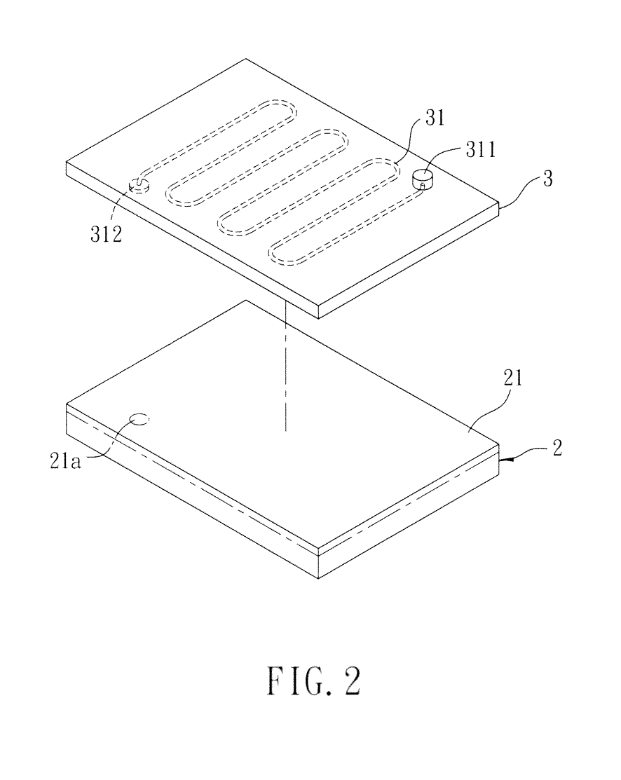

Referring to FIGS. 1 and 2, a microfluidic layer 3 having a microchannel 31 is laminated with the substrate layer 2 so that the microchannel 31 is connected fluidly to the transformative potion 21 havens the temporary shape. Consequently, the preferred embodiment of a microfluidic chip device according to the present invention is formed. The microfluidic layer 3 further has a first hole 311 that is formed on a first surface of the microfluidic layer 3 and that is in spatial communication with the microchannel 31, and a second hole 312 that is formed on a second surface of the microfluidic layer 3 opposite to the first surface, that is in spatial communication with the microchannel 31, and that may be in spatial communication with the indentation 21a of the transformative portion 21. Namely, the microchannel 31 may be in spatial communication with the indentation 21a of the transformative portion 21. The microfluidic layer 3 may be made from glass or a polymer, and may be bonded to the substrate layer 2 by virtue of an adhesive 4.

In this embodiment, the microfluidic layer 3 is made by drilling a substrate made from a cyclic olefin copolymer (COC). Accordingly, the microchannel 31, and the first and second holes 311,312 are formed. A UV curable adhesive 4 is spin-coated onto the second surface of the microfluidic layer 3, which has the second hole 312. The microfluidic layer 3 is disposed on the substrate layer 2 with the second surface thereof facing the transformative portion 21, and with the second hole 312 disposed at a location of the transformative portion 21 with the temporary shape, which corresponds in positron to the indentation 21a of the transformative portion 21 with the memory shape. The assembly of the microfluidic layer 3 and the substrate layer 2 is placed in a UV exposure box and is exposed to UV light such that the microfluidic layer 3 and the transformative portion 21 are bonded to each other (see step (d) of FIG. 1).

The memory shape of the transformative portion 21 is recovered when the transformative portion 21 is activated by an external stimulus, and a fluid driving pressure is produced within the microchannel 31 when the memory shape is recovered. Specifically, when the transformative portion 21 is activated by the external stimulus and hence changes from the temporary shape to the memory shape, a volume of the transformative portion 21 (i.e., a volume of the SMP) changes such that the fluid driving pressure is produced within the microchannel 31. Namely, a pressure change is induced by the volume change of the transformative portion 21.

When a SMP has a low POSS content, thermal stability and melt flowablility of the SMP are low. Accordingly, the memory shape of the transformative portion 21 made from the SMP having the low POSS content may deform before the hot-pressing process such that the volume change of the transformative portion 21 between the temporary shape and the memory shape may be insufficient. Hence, the fluid driving pressure for the pressure change) produced by the insufficient volume change of the transformative portion 21 may be deficient. Preferably, an amount of POSS is not less than 10 wt % based en a total weight of the monomer composition. More preferably, the amount of POSS is not less than 15 wt % based on the total weight of the monomer composition.

In this embodiment, the external stimulus is heat, and the fluid driving pressure is a negative pressure that is produced in the microchannel 31 when the indentation 21a of the transformative portion 21 is recovered. It should be noted that the transformative portion 21 could be designed to produce a positive pressure in the microchannel 31 in other embodiments.

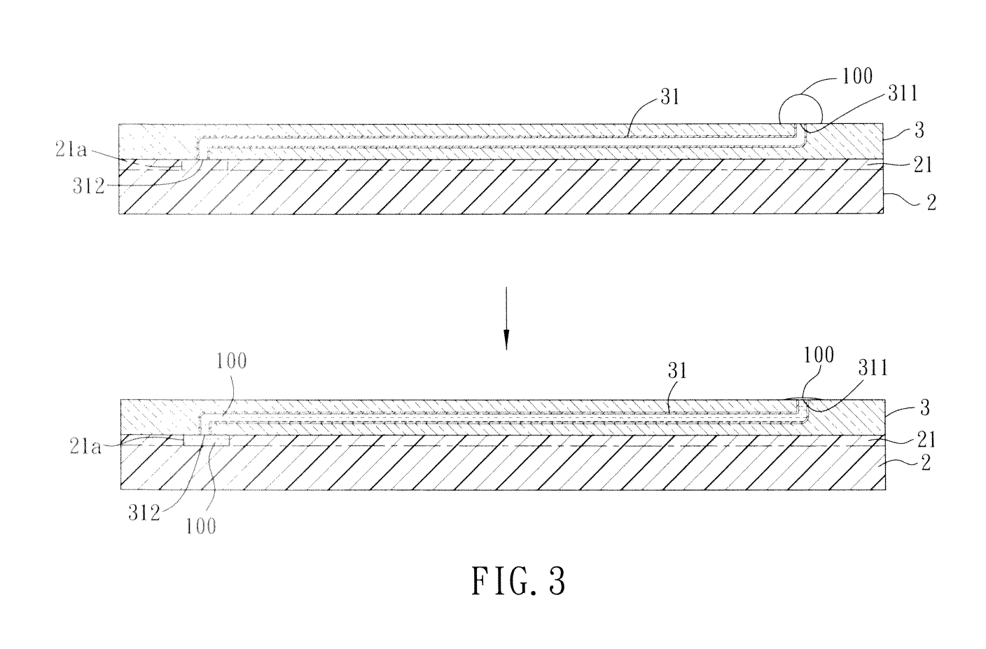

Referring to FIG. 3, how the microfluidic chip device can drive a fluid 100 is illustrated as follows. The fluid 100 is disposed on the first hole 311. When the transformative portion 21 is heated to a temperature higher than T_{g} thereof, the internal energy is released to change the transformative portion 21 from the temporary shape to the memory shape, thereby recovering the indentation 21a. Thus, the volume change of the transformative portion 21 produces the negative pressure in the microchannel 31. As a result, the fluid 100 is sucked into the microchannel 31 by the negative pressure. Accordingly, a driving source (i.e., the transformative portion 21; and a microfluidic. chip (i.e., the microfluidic layer 3) can be integrated by virtue of the method of this invention.

It should be noted that the microfluidic layer 3 and the transformative portion 21 could be detachably connected to each other in other embodiments. Consequently, the substrate layer 2 having the transformative portion 21 with the memory shape may be detached from the microfluidic layer 3, and may be subjected to a hot-pressing process so as to change the transformative portion 21 from the memory shape to the temporary shape. As a result, the substrate layer 2 may be attached to a new microfluidic layer 3 and is considered reusable.

The method of this invention is simple and convenient, and can be easily conducted. A production cost of the microfluidic chip device of this invention is also low.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A method of making a microfluidic chip device,
comprising:
forming a shape memory polymer into a substrate layer having a transformative portion with a memory shape;
processing the substrate layer to change the transformative portion into a temporary shape; and
laminating the substrate layer with a microfluidic layer so that a microchannel of the microfluidic layer is connected fluidly to the transformative portion having the temporary shape;
wherein the memory shape is recovered when the transformative portion is activated by an external stimulus, and a fluid driving pressure is produced within the microchannel when the memory shape is recovered.

2. The method of claim 1, wherein the transformative portion with the memory shape has a surface of the substrate layer, which has an indentation.

3. The method of claim 2, wherein the substrate layer is processed by hot pressing the surface of the substrate layer so that the indentation disappears from the surface of the substrate layer.

4. The method of claim 3, wherein the processing of the substrate layer includes hot-pressing at a temperature not lower than a glass transition temperature of the substrate layer.

5. The method of claim 3, wherein the external stimulus to activate the transformative portion includes heat, and the fluid driving pressure is a negative pressure that is produced in the microchannel when the indentation is recovered.

6. The method of claim 1, wherein the shape memory polymer is made from a monomer composition containing a monomer selected from the group consisting of methyl methacrylate and butyl methacrylate.

7. The method of claim 6, where in the monomer composition further contains polyhedral oligosilsesquioxane.

8. A microfluidic chip device comprising:
a substrate layer made from a shape memory polymer, and including a transformative portion that can change in volume when changing in shape between a memory shape and a temporary shape; and
a microfluidic layer laminated with said substrate layer and having a microchannel that is in fluid communication with said transformative portion;
wherein said transformative portion produces a fluid driving pressure within said microchannel when changing between said memory shape and said temporary shape.

9. The microfluidic chip device of claim 8, wherein said fluid driving pressure is a negative pressure that is produced when said transformative portion changes from said temporary shape to said memory shape.

10. The microfluidic chip device of claim 8, wherein said transformative portion with said memory shape has a surface of said substrate layer, which has an indentation, said indentation disappears from said surface of said substrate layer when said transformative portion changes to said temporary shape, and a negative pressure is produced when said memory shape is recovered from said temporary shape.

11. The microfluidic chip device of claim 8, wherein said transformative portion changes in shape when being subjected to heat.
